(19) United States
(12) Patent Application Publication
(10) Pub. No.: US 2026/0275540 A1
(43) Pub. Date: Sep. 17, 2026

(54) WATER ELECTROLYSIS SYSTEM

(71) Applicant: HONDA MOTOR CO., LTD., TOKYO (JP)

(72) Inventor: Mizuho MURAKI, WAKO-SHI (JP)

(21) Appl. No.: 19/561,677

(22) Filed: Mar. 10, 2026

(30) Foreign Application Priority Data
Mar. 13, 2025 (JP) 2025-040250

(51) Int. Cl. C25B 9/77; C25B 9/67; C25B 15/021; C25B 15/08

(52) U.S. Cl. CPC C25B 9/77; C25B 9/67; C25B 15/021; C25B 15/085

(57) ABSTRACT

A water electrolysis system includes a water electrolysis stack, the water electrolysis stack including a cell stack body in which a plurality of water electrolysis cells for electrolyzing water are stacked, and a first end member and a second end member that sandwich the cell stack body in a stacking direction of the plurality of water electrolysis cells. At least one of the first end member or the second end member includes a gas-liquid separator for separating fluid guided from the cell stack body into gas and liquid.

### CROSS-REFERENCE TO RELATED APPLICATIONS

This application is based upon and claims the benefit of priority from Japanese Patent Application No. 2025-040250 filed on Mar. 13, 2025, the contents of which are incorporated herein by reference.

### BACKGROUND OF THE INVENTION

### Field of the Invention

The present disclosure relates to a water electrolysis system.

### Description of the Related Art

In recent years, research and development has been conducted on water electrolysis systems that contribute to energy efficiency in order to ensure that more people have access to affordable, reliable, sustainable and modern energy.

For example, JP 2010-189707 A discloses a water electrolysis system including a water electrolysis device, an oxygen-side gas-liquid separator connected to the water electrolysis device via a return pipe, and a hydrogen-side gas-liquid separator connected to the water electrolysis device via a high-pressure hydrogen pipe.

### SUMMARY OF THE INVENTION

There has been a demand for a more satisfactory water electrolysis system.

The present disclosure has the object of solving the above-described problem.

An aspect of the present disclosure is characterized by a water electrolysis system comprising a water electrolysis stack, the water electrolysis stack including a cell stack body in which a plurality of water electrolysis cells configured to electrolyze water are stacked, and a first end member and a second end member that are configured to sandwich the cell stack body in a stacking direction of the plurality of water electrolysis cells, wherein at least one of the first end member or the second end member includes a gas-liquid separator configured to separate fluid guided from the cell stack body into gas and liquid.

According to the present disclosure, a more satisfactory water electrolysis system can be provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a block diagram of an energy system including a water electrolysis system according to an embodiment of the present disclosure;

FIG. 2 is a cross-sectional view of a water electrolysis stack;

FIG. 3 is a transverse cross-sectional view taken along line III-III of FIG. 2;

FIG. 4 is a block diagram illustrating a control device of the water electrolysis system; and

FIG. 5 is a cross-sectional view showing a modification of the arrangement of a hydrogen gas lead-out hole.

### DETAILED DESCRIPTION OF THE INVENTION

In the case where the water electrolysis stack and the gas-liquid separator are connected by a pipe, the configuration of the water electrolysis system becomes large. According to the present disclosure, the water electrolysis system can be downsized.

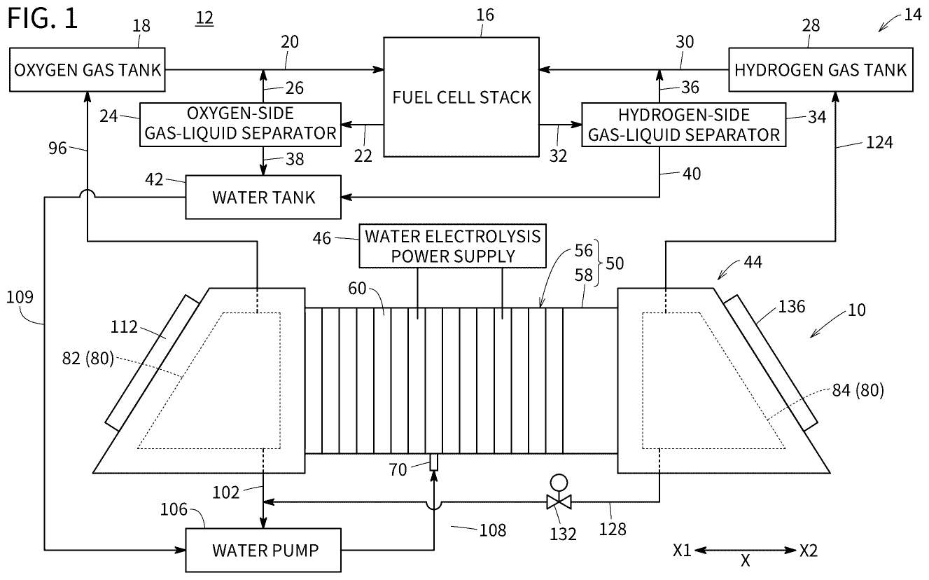

A water electrolysis system 10 according to an embodiment of the present disclosure will be described below with reference to the drawings. FIG. 1 is a block diagram of an energy system 12 including the water electrolysis system 10 according to the embodiment of the present disclosure.

As shown in FIG. 1, the energy system 12 is a circulative renewable energy system. The energy system 12 is a system in which a fuel cell system 14 and the water electrolysis system 10 are combined. The fuel cell system 14 generates electricity and water by an electrochemical reaction between oxygen gas and hydrogen gas. The water electrolysis system 10 generates oxygen gas and hydrogen gas by electrolyzing water. The water electrolysis system 10 uses the water generated by the fuel cell system 14. The fuel cell system 14 uses the oxygen gas and the hydrogen gas generated by the water electrolysis system 10.

Such an energy system 12 can be installed, for example, on the moon's surface. Further, the energy system 12 can also be mounted on a satellite such as an International Space Station (ISS). The energy system 12 is therefore launched on a rocket (not shown).

The fuel cell system 14 includes a fuel cell stack 16. The fuel cell stack 16 is a polymer electrolyte fuel cell (PEFC). The fuel cell stack 16 is formed by stacking a plurality of power generation cells (not shown). The power generation cells generate electric power by an electrochemical reaction between hydrogen gas and oxygen gas.

The fuel cell system 14 includes an oxygen gas tank 18, an oxygen gas supply path 20, an oxygen gas discharge path 22, an oxygen-side gas-liquid separator 24, and an oxygen gas circulation path 26. The oxygen gas tank 18 can be filled with oxygen gas. The oxygen gas supply path 20 is configured to guide the oxygen gas in the oxygen gas tank 18 to the fuel cell stack 16. The oxygen exhaust gas discharged from the fuel cell stack 16 flows through the oxygen gas discharge path 22. The oxygen-side gas-liquid separator 24 separates the oxygen exhaust gas guided from the oxygen gas discharge path 22 into gas and liquid. The oxygen gas circulation path 26 is configured to return the oxygen gas obtained by gas-liquid separation of the oxygen exhaust gas to the oxygen gas supply path 20.

The fuel cell system 14 includes a hydrogen gas tank 28, a hydrogen gas supply path 30, a hydrogen gas discharge path 32, a hydrogen-side gas-liquid separator 34, and a hydrogen gas circulation path 36. The hydrogen gas tank 28 can be filled with hydrogen gas. The hydrogen gas supply path 30 is configured to guide the hydrogen gas in the hydrogen gas tank 28 to the fuel cell stack 16. The hydrogen exhaust gas discharged from the fuel cell stack 16 flows through the hydrogen gas discharge path 32. The hydrogen-side gas-liquid separator 34 separates the hydrogen exhaust gas guided from the hydrogen gas discharge path 32 into gas and liquid. The hydrogen gas circulation path 36 is configured to return the hydrogen gas obtained by gas-liquid separation of the hydrogen exhaust gas to the hydrogen gas supply path 30.

The fuel cell system 14 further includes an oxygen-side drainage path 38, a hydrogen-side drainage path 40, and a water tank 42. The oxygen-side drainage path 38 is configured to guide the water in the oxygen-side gas-liquid separator 24 to the water tank 42. The hydrogen-side drainage path 40 is configured to guide the water in the hydrogen-side gas-liquid separator 34 to the water tank 42. The water tank 42 stores water.

Although other constituent elements may be provided in the fuel cell system 14 apart from the above-described constituent elements, description of such elements will be omitted herein.

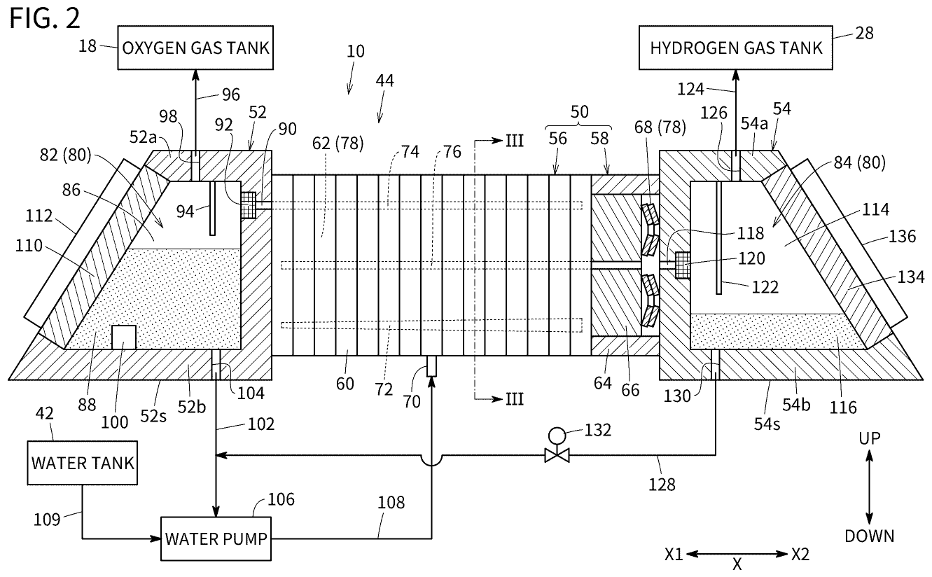

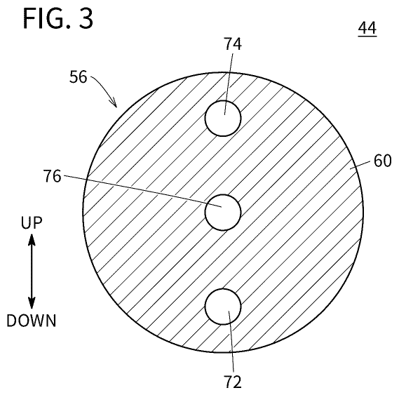

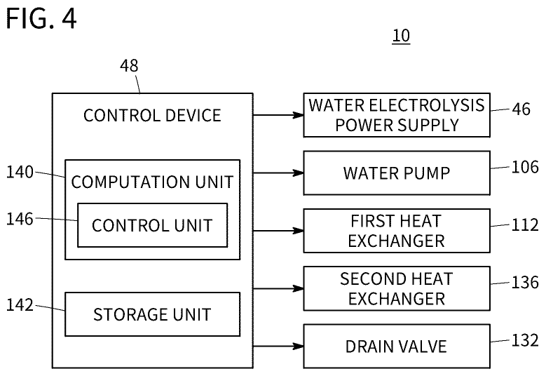

FIG. 2 is a cross-sectional view of a water electrolysis stack 44. FIG. 3 is a transverse cross-sectional view taken along line III-III of FIG. 2. FIG. 4 is a block diagram illustrating a control device 48 of the water electrolysis system 10. As shown in FIGS. 1 to 4, the water electrolysis system 10 includes the water electrolysis stack 44, a water electrolysis power supply 46, and the control device 48. The water electrolysis stack 44 is, for example, an isobaric water electrolysis stack. The water electrolysis stack 44 may be a differential-pressure water electrolysis stack.

As shown in FIG. 2, the water electrolysis stack 44 includes a stack body 50, a first end member 52, and a second end member 54. The stack body 50 is sandwiched between the first end member 52 and the second end member 54 in an X direction. The first end member 52 is adjacent to the stack body 50 in an X1 direction. The second end member 54 is adjacent to the stack body 50 in an X2 direction. The first end member 52 and the second end member 54 are connected to each other by fastening members (bolts and nuts) (not shown). As a result, a tightening load in the stacking direction is applied to the stack body 50.

The stack body 50 includes a cell stack body 56 and a pressing member 58. The cell stack body 56 is formed by stacking a plurality of water electrolysis cells 60. The stacking direction of the plurality of water electrolysis cells 60 (the X direction) lies along the horizontal direction.

The water electrolysis cells 60 each generate oxygen gas and hydrogen gas by electrolyzing water (pure water). Although not shown in detail, the water electrolysis cells 60 each include a membrane electrode assembly, a first current collector, and a second current collector. The membrane electrode assembly includes an electrolyte membrane, a first electrode catalyst layer, and a second electrode catalyst layer. The membrane electrode assembly is also referred to as a catalyst-coated membrane (CCM). The electrolyte membrane is an ion exchange membrane capable of exchanging ions. The electrolyte membrane is, for example, a proton exchange membrane (PEM). The electrolyte membrane may be an anion exchange membrane (AEM). The water electrolysis cells 60 each include a plate spring 62 that can be elastically deformed along the stacking direction of the plurality of water electrolysis cells 60 (X direction).

The pressing member 58 presses the cell stack body 56 in the stacking direction. The pressing member 58 is disposed between the cell stack body 56 and the second end member 54. The pressing member 58 includes a cylinder 64, a piston 66, and a plurality of disc springs 68. The piston 66 and the plurality of disc springs 68 are disposed inside the cylinder 64. The disc springs 68 can be elastically deformed along the stacking direction of the plurality of water electrolysis cells 60 (X direction).

The stack body 50 is provided with a water inlet portion 70, a water supply hole 72, a water discharge hole 74, and a hydrogen gas lead-out hole 76. The water inlet portion 70 introduces water into the cell stack body 56. The water inlet portion 70 is located at an intermediate portion of the cell stack body 56 in the stacking direction. More specifically, the water inlet portion 70 is located at the center of the cell stack body 56 in the stacking direction. The water inlet portion 70 is provided at a lower end portion of the cell stack body 56. That is, water is introduced into the cell stack body 56 from the lower side.

The water supply hole 72 is provided in a portion of the cell stack body 56 below the center in the up-down direction (see FIG. 3). The water supply hole 72 is configured to supply the water introduced from the water inlet portion 70, to each of the plurality of water electrolysis cells 60. The water supply hole 72 extends in the stacking direction of the plurality of water electrolysis cells 60 (the X direction).

The water discharge hole 74 is provided in a portion of the cell stack body 56 above the center in the up-down direction (see FIG. 3). That is, the water discharge hole 74 is located above the water supply hole 72. The water discharge hole 74 is configured to guide the oxygen gas generated in each of the water electrolysis cells 60 and unreacted water to the first end member 52. The water discharge hole 74 extends in the stacking direction of the plurality of water electrolysis cells 60 (the X direction).

The hydrogen gas lead-out hole 76 is provided in the stack body 50. The hydrogen gas lead-out hole 76 is provided in a central portion of the stack body 50 in the up-down direction (see FIG. 3). The hydrogen gas lead-out hole 76 is located between the water supply hole 72 and the water discharge hole 74. The hydrogen gas lead-out hole 76 is configured to guide the hydrogen gas generated in each of the water electrolysis cells 60 to the second end member 54. The hydrogen gas lead-out hole 76 extends in the stacking direction of the plurality of water electrolysis cells 60 (the X direction).

In the present embodiment, the water introduced from the water inlet portion 70 is guided to the plurality of water electrolysis cells 60 via the water supply hole 72 and electrolyzed. The oxygen gas generated by the electrolysis of the water and unreacted water are guided to the first end member 52 via the water discharge hole 74. In such a configuration, the water introduced from the water inlet portion 70 into the water supply hole 72 easily flows in a direction approaching the first end member 52 (the X1 direction). In this case, the amount of water supplied to the water electrolysis cells 60 located further in the X2 direction than the water inlet portion 70 among the plurality of water electrolysis cells 60 tends to be smaller than the amount of water supplied to the water electrolysis cells 60 located further in the X1 direction than the water inlet portion 70 among the plurality of water electrolysis cells 60.

Therefore, in the present embodiment, the water supply hole 72 is formed such that the flow resistance thereof increases toward the first end member 52. In other words, the water supply hole 72 is formed such that the cross-sectional area thereof decreases toward the X1 direction side. That is, the water supply hole 72 is tapered toward the X1 direction side. In this case, the water introduced from the water inlet portion 70 into the water supply hole 72 easily flows also in the X2 direction. Therefore, it is possible to suppress variation in the amount of water supplied from the water supply hole 72 to the plurality of water electrolysis cells 60.

It should be noted that, in the example of FIG. 2, a difference in flow resistance is not provided in the water discharge hole 74. The water discharge hole 74 may be formed such that the flow resistance thereof increases toward the first end member 52. In this case as well, it is possible to suppress variation in the amount of water supplied from the water supply hole 72 to the plurality of water electrolysis cells 60. That is, in the present embodiment, at least one of the water supply hole 72 or the water discharge hole 74 may be formed such that the flow resistance thereof increases toward the first end member 52.

The first end member 52 and the second end member 54 sandwich the cell stack body 56 in the stacking direction of the plurality of water electrolysis cells 60. The water electrolysis stack 44 includes spring members 78 that can be elastically deformed along the stacking direction. The spring members 78 include the plate springs 62 of the respective water electrolysis cells 60 and the disc springs 68 of the pressing member 58. The first end member 52 and the second end member 54 support the cell stack body 56 so that the stacking direction of the plurality of water electrolysis cells 60 lies along the horizontal direction.

In the case where the water electrolysis stack 44 is vertically placed so that the stacking direction of the plurality of water electrolysis cells 60 lies along the direction of gravity, the water electrolysis stack 44 is likely to fall down when subjected to vibration in the horizontal direction. In particular, when the number of the stacked water electrolysis cells 60 is increased, the height dimension of the water electrolysis stack 44 is increased and the height position of the center of gravity is shifted upward, and therefore, the water electrolysis stack 44 is more likely to fall down. In this case, it is necessary to increase the rigidity of the root portion of the water electrolysis stack 44 or provide a fixing jig or the like, and therefore the weight of the water electrolysis stack 44 is likely to increase and the degree of freedom in design is likely to be limited. Further, the plurality of spring members 78 are stacked in the vertical direction in a state where the end member located on the upper side is not held (not installed on the ground), and therefore, when the water electrolysis stack 44 is subjected to vibration in the vertical direction, resonance such as expansion and contraction of the water electrolysis stack 44 in the up-down direction may occur.

However, in the present embodiment, the water electrolysis stack 44 can be placed horizontally so that the stacking direction of the plurality of water electrolysis cells 60 lies along the horizontal direction, and therefore, the height position of the center of gravity of the water electrolysis stack 44 can be set to a relatively low position. As a result, it is possible to make the water electrolysis stack 44 less likely to fall down when subjected to vibration in the horizontal direction. Further, since the cell stack body 56 is sandwiched between the first end member 52 and the second end member 54, the rigidity of the entire water electrolysis stack 44 can be increased. Therefore, it is not necessary to separately provide a fixing member, and the degree of freedom in design of the water electrolysis stack 44 can be increased. Furthermore, even when the number of the stacked water electrolysis cells 60 is increased, the height position of the center of gravity of the water electrolysis stack 44 is not shifted upward, and therefore, the same design (components) can be adopted regardless of the number of the stacked water electrolysis cells 60. In addition, the plurality of spring members 78 are stacked along the horizontal direction in a state where the first end member 52 and the second end member 54 are held (installed on the ground), and therefore, the occurrence of resonance such as expansion and contraction of the water electrolysis stack 44 can be suppressed.

The first end member 52 has a flat bottom surface 52s, and the second end member 54 has a flat bottom surface 54S. This enables the water electrolysis stack 44 to be stably installed on a flat installation surface (not shown). The first end member 52 and the second end member 54 each have a dimension in the X direction that gradually decreases upward. This can suppress a situation in which the first end member 52 and the second end member 54 become larger than necessary. That is, the water electrolysis stack 44 can be made relatively lightweight.

Each of the first end member 52 and the second end member 54 includes a gas-liquid separator 80. In this case, the water electrolysis system 10 can be downsized as compared to a case where the gas-liquid separator 80 is provided separately from the water electrolysis stack 44 and the water electrolysis stack 44 and the gas-liquid separator 80 are connected by a pipe.

The gas-liquid separator 80 provided in the first end member 52 is a first gas-liquid separator 82 that separates the oxygen gas guided from the cell stack body 56 into gas and liquid. The gas-liquid separator 80 provided in the second end member 54 is a second gas-liquid separator 84 that separates the hydrogen gas guided from the cell stack body 56 into gas and liquid. The second gas-liquid separator 84 has a volume twice the volume of the first gas-liquid separator 82. That is, the second end member 54 is larger than the first end member 52. It should be noted that, in FIGS. 1 and 2, the first end member 52 and the second end member 54 are illustrated as having the same size for convenience.

In this case, the pressure of the oxygen gas in the first gas-liquid separator 82 and the pressure of the hydrogen gas in the second gas-liquid separator 84 can be equalized. In addition, the pressure rise rates of the oxygen gas and the hydrogen gas can be equalized. Furthermore, since the natural frequency of the first end member 52 and the natural frequency of the second end member 54 can be made different from each other, it is possible to suppress the vibration of the water electrolysis stack 44 when the water electrolysis system 10 is launched on a rocket.

The first gas-liquid separator 82 includes a first gas-liquid separator body portion (a gas-liquid separator body portion) 86 and a first reservoir portion (a reservoir portion) 88. The first reservoir portion 88 is located below the first gas-liquid separator body portion 86 and can store liquid water. The first end member 52 is provided with a first lead-out path 90 configured to guide, to the first gas-liquid separator body portion 86, the oxygen gas and the unreacted water guided from the water discharge hole 74.

The first end member 52 is provided with an impurity removing member 92 for removing impurities (hydrogen components) from fluid (the oxygen gas and the unreacted water) guided from the cell stack body 56. That is, the impurity removing member 92 can remove the hydrogen component (cross-leaked hydrogen component) that has permeated through the electrolyte membrane of each of the water electrolysis cells 60 and has been guided to the water discharge hole 74. As a result, the purity of the oxygen gas guided to the first gas-liquid separator 82 can be increased.

The impurity removing member 92 is, for example, a catalytic recombiner. In this case, the impurity removing member 92 can recombine hydrogen and oxygen to generate water. Examples of the catalyst of the impurity removing member 92 include platinum, palladium, and ruthenium, but are not limited thereto. The impurity removing member 92 may be formed in a pellet shape or a honeycomb shape, for example.

The impurity removing member 92 is disposed at the outlet of the first lead-out path 90. As a result, the hydrogen component can be efficiently removed from the oxygen gas guided from the cell stack body 56. In addition, the water generated by the impurity removing member 92 can be dropped into the first gas-liquid separator 82.

The first end member 52 is provided with a gas-liquid separation promoting member 94 for promoting gas-liquid separation of the fluid guided to the first gas-liquid separator 82. The gas-liquid separation promoting member 94 faces the outlet of the first lead-out path 90. As the gas-liquid separation promoting member 94, for example, a baffle plate, an impactor, a labyrinth structure, or the like can be adopted, but the gas-liquid separation promoting member 94 can be set as appropriate.

A first gas communication hole 98 configured to guide the oxygen gas in the first gas-liquid separator body portion 86 of the first gas-liquid separator 82 to an oxygen gas lead-out path 96 is formed in an upper wall portion 52a of the first end member 52. The oxygen gas lead-out path 96 connects the first end member 52 and the oxygen gas tank 18.

The first reservoir portion 88 is provided with an ion exchange member 100. The ion exchange member 100 can exchange ions of the liquid water stored in the first reservoir portion 88. As a result, impurities (for example, metal ions) can be removed from the liquid water stored in the first reservoir portion 88 of the first gas-liquid separator 82. The ion exchange member 100 is formed by, for example, accommodating an ion exchange resin formed in a granular shape in a mesh container. The ion exchange member 100 may be formed of a plate-shaped ion exchange resin.

A first drain hole 104 configured to guide the water stored in the first reservoir portion 88 to a first water lead-out path 102 is formed in a bottom wall portion 52b of the first end member 52. The first water lead-out path 102 connects the first end member 52 and a water pump 106. The water pump 106 is connected to the water inlet portion 70 via a water circulation path 108. Further, the water pump 106 is connected to the water tank 42 via a water supply path 109. That is, water stored in the water tank 42 is supplied to the water pump 106 via the water supply path 109. The water pump 106 sends the water stored in the first reservoir portion 88 to the cell stack body 56.

The first end member 52 is provided with a lid portion 110 that can be opened and closed. The lid portion 110 forms a side wall portion of the first end member 52 that is located on the opposite side to the stack body 50. By opening the lid portion 110, maintenance of the inside of the first gas-liquid separator 82 can be performed. That is, by opening the lid portion 110, the work of replacing the impurity removing member 92 and the ion exchange member 100, for example, can be easily performed. The lid portion 110 is inclined upward in the X2 direction. As a result, since the lid portion 110 can be made relatively large, the inside of the first end member 52 (the first gas-liquid separator 82) is easily accessed.

The lid portion 110 (the side wall portion) is provided with a heat exchanger 112 (hereinafter, may be referred to as a “first heat exchanger 112”) for adjusting the temperature of the fluid in the first gas-liquid separator 82. As a result, even in the case where the water electrolysis system 10 is installed in an environment where heat conduction hardly occurs, such as the moon's surface, the temperatures of the cell stack body 56 and the oxygen gas can be easily adjusted. The first heat exchanger 112 is attached to a surface of the lid portion 110 that faces outward.

The first heat exchanger 112 may include, for example, a coolant circulation device (a chiller). The coolant that has flowed through the fuel cell stack 16 may flow through the first heat exchanger 112. In this case, the temperature of the coolant can be adjusted by the heat generated in the fuel cell stack 16.

The first heat exchanger 112 is disposed so as to extend over the first gas-liquid separator body portion 86 and the first reservoir portion 88. As a result, the temperatures of both the gas (the oxygen gas) and the liquid (the liquid water) in the first gas-liquid separator 82 can be adjusted by the first heat exchanger 112.

The second gas-liquid separator 84 includes a second gas-liquid separator body portion (the gas-liquid separator body portion) 114 and a second reservoir portion (the reservoir portion) 116. The second reservoir portion 116 is located below the second gas-liquid separator body portion 114 and can store liquid water. The second end member 54 is provided with a second lead-out path 118 configured to guide, to the second gas-liquid separator body portion 114, the hydrogen gas guided from the hydrogen gas lead-out hole 76.

The second end member 54 is provided with an impurity removing member 120 for removing impurities (oxygen components) from the fluid (the hydrogen gas) guided from the cell stack body 56. That is, the impurity removing member 120 can remove the oxygen component (cross-leaked oxygen component) that has permeated through the electrolyte membrane of each of the water electrolysis cells 60 and has been guided to the hydrogen gas lead-out hole 76. As a result, the purity of the hydrogen gas guided to the second gas-liquid separator 84 can be increased. The impurity removing member 120 can be configured in the same manner as the impurity removing member 92.

The impurity removing member 120 is disposed at the outlet of the second lead-out path 118. As a result, the oxygen component can be efficiently removed from the hydrogen gas guided from the cell stack body 56. In addition, the water generated by the impurity removing member 120 can be dropped into the second gas-liquid separator 84.

The second end member 54 is provided with a gas-liquid separation promoting member 122 for promoting gas-liquid separation of the fluid guided to the second gas-liquid separator 84. The gas-liquid separation promoting member 122 faces the outlet of the second lead-out path 118. The gas-liquid separation promoting member 122 can be configured in the same manner as the gas-liquid separation promoting member 94.

A second gas communication hole 126 configured to guide the hydrogen gas in the second gas-liquid separator body portion 114 to a hydrogen gas lead-out path 124 is formed in an upper wall portion 54a of the second end member 54. The hydrogen gas lead-out path 124 connects the second end member 54 and the hydrogen gas tank 28.

A second drain hole 130 configured to guide the water stored in the second reservoir portion 116 of the second gas-liquid separator 84 to a second water lead-out path 128 is formed in a bottom wall portion 54b of the second end member 54. The second water lead-out path 128 connects the second end member 54 and the first water lead-out path 102. The second water lead-out path 128 is provided with a drain valve 132 configured to open and close the second water lead-out path 128. The drain valve 132 is a solenoid valve. The water stored in the second reservoir portion 116 can be discharged by the pressure of the hydrogen gas in the second gas-liquid separator 84 and the suction force of the water pump 106.

The second end member 54 is provided with a lid portion 134 that can be opened and closed. The lid portion 134 forms a side wall portion of the second end member 54 that is located on the opposite side to the stack body 50. By opening the lid portion 134, maintenance of the inside of the second gas-liquid separator 84 can be performed. That is, by opening the lid portion 134, the work of replacing the impurity removing member 120, for example, can be easily performed. The lid portion 134 is inclined upward in the X1 direction. As a result, since the lid portion 134 can be made relatively large, the inside of the second end member 54 (the second gas-liquid separator 84) is easily accessed.

The lid portion 134 (the side wall portion) is provided with a heat exchanger 136 (hereinafter, may be referred to as a “second heat exchanger 136”) for adjusting the temperature of the fluid in the second gas-liquid separator 84. As a result, even in the case where the water electrolysis system 10 is installed in an environment where heat conduction hardly occurs, such as the moon's surface, the temperatures of the cell stack body 56 and the hydrogen gas can be easily adjusted. The second heat exchanger 136 is attached to a surface of the lid portion 134 that faces outward. The second heat exchanger 136 can be configured in the same manner as the first heat exchanger 112.

The second heat exchanger 136 is disposed so as to extend over the second gas-liquid separator body portion 114 and the second reservoir portion 116. As a result, the temperatures of both the gas (the hydrogen gas) and the liquid (the liquid water) in the second gas-liquid separator 84 can be adjusted by the second heat exchanger 136.

As shown in FIG. 1, the water electrolysis power supply 46 is a DC power supply. The water electrolysis power supply 46 supplies an electric current to the first current collector and the second current collector of each of the water electrolysis cells 60. A voltage is applied between the first current collector and the second current collector by the water electrolysis power supply 46.

As shown in FIG. 4, the control device 48 includes a computation unit 140 and a storage unit 142. Although other constituent elements may be provided in the control device 48 apart from these constituent elements, description of such elements will be omitted herein. A program for operating the water electrolysis system 10 according to the present embodiment can be installed in the storage unit 142.

The computation unit 140 is constituted by a processor such as a central processing unit (CPU) or a graphics processing unit (GPU). That is, the computation unit 140 is constituted by processing circuitry.

The computation unit 140 includes a control unit 146. The control unit 146 can be realized by the computation unit 140 executing a program stored in the storage unit 142.

At least part of the control unit 146 may be realized by an integrated circuit such as an application specific integrated circuit (ASIC) or a field-programmable gate array (FPGA). At least part of the control unit 146 may be constituted by an electronic circuit including a discrete device. The control unit 146 controls the water electrolysis power supply 46, the water pump 106, the first heat exchanger 112, the second heat exchanger 136, and the drain valve 132.

Next, the basic operation of the water electrolysis system 10 will be described. The control unit 146 drives the water pump 106 to supply water to the water inlet portion 70, and drives the water electrolysis power supply 46 to cause an electric current to flow through the first current collector and the second current collector. The water supplied to the water inlet portion 70 is supplied to each of the plurality of water electrolysis cells 60 via the water supply hole 72. In each of the water electrolysis cells 60, water is electrolyzed by applying a voltage between the first current collector and the second current collector.

The oxygen gas generated in each of the water electrolysis cells 60 and the unreacted water are guided to the first lead-out path 90 via the water discharge hole 74. The oxygen gas and the water guided to the first lead-out path 90 flow into the first gas-liquid separator 82 after the hydrogen component is removed by the impurity removing member 92. The hydrogen gas (including water vapor) generated in each of the water electrolysis cells 60 is guided to the second lead-out path 118 via the hydrogen gas lead-out hole 76. The hydrogen gas guided to the second lead-out path 118 flows into the second gas-liquid separator 84 after the oxygen component is removed by the impurity removing member 120.

The oxygen gas that has flowed into the first gas-liquid separator 82 is separated into gas and liquid by the gas-liquid separation promoting member 94. The water content separated from the oxygen gas is stored in the first reservoir portion 88 of the first gas-liquid separator 82. Impurities (metal ions) are removed from the water stored in the first reservoir portion 88 by the ion exchange member 100. The water stored in the first reservoir portion 88 is sent to the water inlet portion 70 by the water pump 106. The oxygen gas from which the water content has been removed is filled into the oxygen gas tank 18 via the first gas communication hole 98 and the oxygen gas lead-out path 96.

The hydrogen gas that has flowed into the second gas-liquid separator 84 is separated into gas and liquid by the gas-liquid separation promoting member 122. The water content separated from the hydrogen gas is stored in the second reservoir portion 116 of the second gas-liquid separator 84. The hydrogen gas from which the water content has been removed is filled into the hydrogen gas tank 28 via the second gas communication hole 126 and the hydrogen gas lead-out path 124.

When the water electrolysis stack 44 is started, the control unit 146 controls the first heat exchanger 112 to heat the first gas-liquid separator 82 and controls the second heat exchanger 136 to heat the second gas-liquid separator 84. As a result, the water stored in the first reservoir portion 88 of the first gas-liquid separator 82 is heated by the first heat exchanger 112, and the water stored in the second reservoir portion 116 of the second gas-liquid separator 84 is heated by the second heat exchanger 136. Therefore, the temperature of the cell stack body 56 can be efficiently raised from both sides in the stacking direction of the plurality of water electrolysis cells 60.

During the steady operation of the water electrolysis stack 44, the control unit 146 controls the first heat exchanger 112 to cool the first gas-liquid separator 82, and controls the second heat exchanger 136 to cool the second gas-liquid separator 84. As a result, excessive rise of the temperature of the cell stack body 56 can be suppressed during the steady operation of the water electrolysis stack 44. Further, since the water vapor in the first gas-liquid separator body portion 86 of the first gas-liquid separator 82 can be condensed, the oxygen gas can be efficiently separated into gas and liquid. Further, since the water vapor in the second gas-liquid separator body portion 114 of the second gas-liquid separator 84 can be condensed, the hydrogen gas can be efficiently separated into gas and liquid.

When the operation of the water electrolysis stack 44 is stopped, the control unit 146 performs a depressurization process of reducing the pressure inside the water electrolysis stack 44 by opening a depressurization valve (on-off valve) provided in a depressurization line (not shown). In this case, the control unit 146 controls the drain valve 132 to open the second water lead-out path 128. As a result, the water stored in the second reservoir portion 116 of the second gas-liquid separator 84 is returned to the first water lead-out path 102 through the second water lead-out path 128.

According to the present embodiment, since at least one of the first end member 52 or the second end member 54 includes the gas-liquid separator 80, the water electrolysis system 10 can be downsized as compared to a case where the water electrolysis stack 44 and the gas-liquid separator 80 are connected by a pipe. Therefore, a more satisfactory water electrolysis system 10 can be provided.

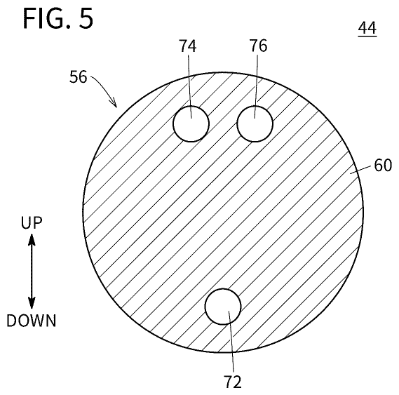

The present embodiment is not limited to the configuration described above. FIG. 5 is a cross-sectional view showing a modification of the arrangement of the hydrogen gas lead-out hole 76. As shown in FIG. 5, the hydrogen gas lead-out hole 76 may be provided in a portion of the stack body 50 above the center in the up-down direction. In the example of FIG. 5, the hydrogen gas lead-out hole 76 is adjacent to the water discharge hole 74 in the horizontal direction. In this case, the second lead-out path 118 communicating with the hydrogen gas lead-out hole 76 can be provided at a relatively high position in the second end member 54, and therefore, a situation can be suppressed in which the water stored in the second reservoir portion 116 flows into the second lead-out path 118.

In the present embodiment, one of the first gas-liquid separator 82 or the second gas-liquid separator 84 may be omitted.

The following supplementary notes are further disclosed in relation to the above-described embodiment.

### Supplementary Note 1

The water electrolysis system (10) of the present disclosure includes the water electrolysis stack (44), the water electrolysis stack including the cell stack body (56) in which the plurality of water electrolysis cells (60) configured to electrolyze water are stacked, and the first end member (52) and the second end member (54) that are configured to sandwich the cell stack body in the stacking direction of the plurality of water electrolysis cells, wherein at least one of the first end member or the second end member includes the gas-liquid separator (80) configured to separate fluid guided from the cell stack body into gas and liquid.

According to such a configuration, since at least one of the first end member or the second end member includes the gas-liquid separator, the water electrolysis system can be downsized as compared to a case where the water electrolysis stack and the gas-liquid separator are connected by a pipe. Therefore, a more satisfactory water electrolysis system can be provided.

### Supplementary Note 2

In the water electrolysis system according to Supplementary Note 1, the first end member and the second end member may each include the gas-liquid separator.

According to such a configuration, the water electrolysis system can be further downsized.

### Supplementary Note 3

In the water electrolysis system according to Supplementary Note 2, the water electrolysis stack may include the spring member (78) that is elastically deformable along the stacking direction, and the first end member and the second end member may support the cell stack body in a manner so that the stacking direction lies along the horizontal direction.

In the case where the water electrolysis stack is vertically placed so that the stacking direction lies along the direction of gravity, the water electrolysis stack is likely to fall down when subjected to vibration in the horizontal direction. In particular, when the number of the stacked water electrolysis cells is increased, the height dimension of the water electrolysis stack is increased and the height position of the center of gravity is shifted upward, and therefore, the water electrolysis stack is more likely to fall down. In this case, it is necessary to increase the rigidity of the root portion of the water electrolysis stack or to provide a fixing jig or the like, and therefore the weight of the water electrolysis stack is likely to increase and the degree of freedom in design is likely to be limited. Further, the plurality of spring members are stacked in the vertical direction in a state where the end member located on the upper side is not held (not installed on the ground), and therefore, when the water electrolysis stack is subjected to vibration in the vertical direction, resonance such as expansion and contraction of the water electrolysis stack in the up-down direction may occur.

According to the water electrolysis system described in Supplementary Note 3, the water electrolysis stack can be placed horizontally so that the stacking direction lies along the horizontal direction, and therefore, the height position of the center of gravity of the water electrolysis stack can be set to a relatively low position. As a result, it is possible to make the water electrolysis stack less likely to fall down when subjected to vibration in the horizontal direction. Further, since the cell stack body is sandwiched between the first end member and the second end member, the rigidity of the entire water electrolysis stack can be increased. Therefore, it is not necessary to separately provide a fixing member, and the degree of freedom in design of the water electrolysis stack can be increased. Furthermore, even when the number of the stacked water electrolysis cells is increased, the height position of the center of gravity of the water electrolysis stack is not shifted upward, and therefore, the same design (components) can be adopted regardless of the number of the stacked water electrolysis cells. In addition, the plurality of spring members are stacked along the horizontal direction in a state where the first end member and the second end member are held (installed on the ground), and therefore, the occurrence of resonance such as expansion and contraction of the water electrolysis stack can be suppressed.

### Supplementary Note 4

In the water electrolysis system according to Supplementary Note 3, the water inlet portion (70) configured to introduce water into the cell stack body may be provided at a lower end portion of the cell stack body.

### Supplementary Note 5

In the water electrolysis system according to Supplementary Note 4, the water inlet portion may be located at the intermediate portion of the cell stack body in the stacking direction, the water electrolysis stack may be provided with: the water supply hole (72) extending along the stacking direction and configured to supply, to the plurality of water electrolysis cells, the water introduced from the water inlet portion; and the water discharge hole (74) extending along the stacking direction and configured to guide, to the gas-liquid separator provided in the first end member, the water having flowed through the plurality of water electrolysis cells, and at least one of the water supply hole or the water discharge hole may be formed to have a flow resistance that increases toward the first end member.

According to such a configuration, it is possible to suppress variation in the amount of water supplied from the water supply hole to the plurality of water electrolysis cells.

### Supplementary Note 6

In the water electrolysis system according to any one of Supplementary Notes 2 to 5, the first end member and the second end member may each be provided with the heat exchanger (112, 136).

According to such a configuration, even in the case where the water electrolysis system is installed in an environment where heat conduction hardly occurs, such as the moon's surface, the temperatures of the cell stack body, the oxygen gas, and the hydrogen gas can be adjusted.

### Supplementary Note 7

In the water electrolysis system according to Supplementary Note 6, the gas-liquid separator may include the gas-liquid separator body portion (86, 114) and the reservoir portion (88, 116) located below the gas-liquid separator body portion and configured to store liquid water, and the heat exchanger may be disposed so as to extend over the gas-liquid separator body portion and the reservoir portion.

According to such a configuration, the temperatures of both the gas and the liquid in the gas-liquid separator can be adjusted by the heat exchanger.

### Supplementary Note 8

The water electrolysis system according to Supplementary Note 7 may further include the control device (48) configured to control the heat exchanger, wherein the control device may control the heat exchanger to heat the gas-liquid separator when the water electrolysis stack is started.

According to such a configuration, the temperature of the cell stack body can be efficiently raised from both sides in the stacking direction of the plurality of water electrolysis cells when the water electrolysis stack is started.

### Supplementary Note 9

In the water electrolysis system according to Supplementary Note 8, the control device may control the heat exchanger to cool the gas-liquid separator during the steady operation of the water electrolysis stack.

According to such a configuration, excessive rise of the temperature of the cell stack body can be suppressed during the steady operation of the water electrolysis stack. Further, since the water vapor in the gas-liquid separator can be condensed, the water content can be efficiently separated from the gas in the gas-liquid separator.

### Supplementary Note 10

In the water electrolysis system according to any one of Supplementary Notes 2 to 9, the gas-liquid separator provided in the first end member may be the first gas-liquid separator (82) configured to separate the oxygen gas guided from the cell stack body into gas and liquid, the gas-liquid separator provided in the second end member may be the second gas-liquid separator (84) configured to separate the hydrogen gas guided from the cell stack body into gas and liquid, and the second gas-liquid separator may have a volume twice the volume of the first gas-liquid separator.

According to such a configuration, the pressure of the oxygen gas in the first gas-liquid separator and the pressure of the hydrogen gas in the second gas-liquid separator can be equalized. In addition, the pressure rise rates of the oxygen gas and the hydrogen gas can be equalized. Furthermore, since the natural frequency of the first end member and the natural frequency of the second end member can be made different from each other, it is possible to suppress the vibration of the water electrolysis stack when the water electrolysis system is launched on a rocket.

### Supplementary Note 11

In the water electrolysis system according to any one of Supplementary Notes 2 to 10, the first end member and the second end member may each be provided with an impurity removing member (92, 120) configured to remove impurities from the fluid guided from the cell stack body.

According to such a configuration, the purity of the oxygen gas and the hydrogen gas can be increased.

Although the present disclosure has been described in detail, the present disclosure is not limited to the above-described individual embodiments. Various additions, replacements, modifications, partial deletions, and the like can be made to these embodiments without departing from the essence and gist of the present disclosure or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A water electrolysis system comprising a water electrolysis stack, the water electrolysis stack including a cell stack body in which a plurality of water electrolysis cells configured to electrolyze water are stacked, and a first end member and a second end member that are configured to sandwich the cell stack body in a stacking direction of the plurality of water electrolysis cells,
wherein at least one of the first end member or the second end member includes a gas-liquid separator configured to separate fluid guided from the cell stack body into gas and liquid.

2. The water electrolysis system according to claim 1, wherein
the first end member and the second end member each include the gas-liquid separator.

3. The water electrolysis system according to claim 2, wherein
the water electrolysis stack includes a spring member that is elastically deformable along the stacking direction, and
the first end member and the second end member support the cell stack body in a manner so that the stacking direction lies along a horizontal direction.

4. The water electrolysis system according to claim 3, wherein
a water inlet portion configured to introduce water into the cell stack body is provided at a lower end portion of the cell stack body.

5. The water electrolysis system according to claim 4, wherein
the water inlet portion is located at an intermediate portion of the cell stack body in the stacking direction,
the water electrolysis stack is provided with:
a water supply hole extending along the stacking direction and configured to supply, to the plurality of water electrolysis cells, the water introduced from the water inlet portion; and
a water discharge hole extending along the stacking direction and configured to guide, to the gas-liquid separator provided in the first end member, the water having flowed through the plurality of water electrolysis cells, and
at least one of the water supply hole or the water discharge hole is formed to have a flow resistance that increases toward the first end member.

6. The water electrolysis system according to claim 2, wherein
the first end member and the second end member are each provided with a heat exchanger.

7. The water electrolysis system according to claim 6, wherein
the gas-liquid separator includes:
a gas-liquid separator body portion; and
a reservoir portion located below the gas-liquid separator body portion and configured to store liquid water, and
the heat exchanger is disposed so as to extend over the gas-liquid separator body portion and the reservoir portion.

8. The water electrolysis system according to claim 7, further comprising a control device configured to control the heat exchanger, wherein
the control device controls the heat exchanger to heat the gas-liquid separator when the water electrolysis stack is started.

9. The water electrolysis system according to claim 8, wherein
the control device controls the heat exchanger to cool the gas-liquid separator during a steady operation of the water electrolysis stack.

10. The water electrolysis system according to claim 2, wherein
the gas-liquid separator provided in the first end member is a first gas-liquid separator configured to separate oxygen gas guided from the cell stack body into gas and liquid,
the gas-liquid separator provided in the second end member is a second gas-liquid separator configured to separate hydrogen gas guided from the cell stack body into gas and liquid, and
the second gas-liquid separator has a volume twice a volume of the first gas-liquid separator.

11. The water electrolysis system according to claim 2, wherein
the first end member and the second end member are each provided with an impurity removing member configured to remove impurities from the fluid guided from the cell stack body.
